(19) United States
(12) Patent Application Publication
(10) Pub. No.: US 2009/0199133 A1
(43) Pub. Date: Aug. 6, 2009

(54) GENERATING A DESTINATION LIST UTILIZING USAGE DATA

(75) Inventors: REBECCA J. DEUTSCH, REDMOND, WA (US); RANDALL K. WINJUM, VASHON, WA (US); PATRICE L. MINER, KIRKLAND, WA (US); Benjamin Betz, Redmond, WA (US); ANDREW JENNINGS, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/025,905

(22) Filed: Feb. 5, 2008

(51) Int. Cl. G06F 3/048; G06F 7/00; G06F 17/30

(52) U.S. Cl. 715/811; 707/102; 707/E17.005

(57) ABSTRACT

Computer-readable media, computerized methods, and computer systems for generating a destination list from usage data captured at a data store and for rending destinations within a submenu area upon detecting a request from a user. Generating the destination list may involve selecting items from a listing of frequently used items, a listing of recently used items, or any other listing of items compiled internal to an operating system or provided by a target application. Typically, the items are selected according to configuration settings of the destination list. Rendering destinations within the submenu area may involve accessing the destination list by selecting a split button proximate to a presentation of an application launcher. Typically, the destination list references items managed by an application invoked by the application launcher. Destinations retrieved from the destination list are populated into the submenu area based on size characteristics thereof.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Presently, operating systems provide a variety of utilities that assist a user in locating and opening files at a user interface (UI) that is presented at a display device (e.g., computer monitor, screen on a mobile device, and the like). However, users must perform many steps to locate and open desired files. For instance, users must find the application that manages the file they want to access, launch the application, and then find and launch the file as well. In some instances, operating systems have attempted to expedite opening files that have been recently viewed by promoting frequently used applications associated with the recently opened files to a list. This list of applications is typically viewable upon accessing a main application menu. However, this list handles a small number of applications, and selection of one of these applications does not surface a link to the recent files. In addition, the user must still perform the steps involved with finding a file upon launching the appropriate application. These steps remain particularly difficult because files are often stored in many different locations (e.g., locally, remotely on another computer or device, or on the Web). As such, present schemes for providing a shortcut to desirable files remain inefficient and time-consuming.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to computer-readable media, methods, and a user interface (UI) for generating a destination list by capturing usage data for a user, and for rendering the destination list at the UI upon receiving a user-initiated indication to view the destination list. Initially, usage data (e.g., information derived from user-initiated activity) that corresponds to a target application is monitored. In particular, upon detecting a user-initiated action (e.g., accessing an item managed by the target application), a timestamp cataloging the activity is automatically captured. In embodiments, a score is determined for each item managed by the target application by aggregating timestamps associated with each item. While monitoring, a listing of recently used items is dynamically built according to the timestamps associated with each item. Also, a listing of frequently used items is dynamically built according to the score associated with each item. In particular, building the listing of frequently used items includes, at least, the following steps: applying a decay algorithm to the determined scores, comparing the determined scores against a predefined threshold score, and populating the listing of frequently used items with items having a score that overcomes the predefined score. Destinations to the items within the listings of recently used items and frequently used items are derived and stored in a destination list. Typically, the size and the content of the destination list is governed by the configuration settings.

Accordingly, the destination list is available for presentation at a user-interface upon detecting a request from a user. In particular, a list-generation procedure is initiated upon receiving a request (e.g., a user-initiated indication to view the destination list). The list-generation process includes, at least, the following steps: accessing a data store to retrieve the listings of the recently used items and the frequently used items; identifying item shells associated with items within the listings; deriving destinations from the item shells; determining properties of a submenu area allocated for the destination list; and populating the submenu area with the destinations according to the properties. A destination list may be surfaced on the UI. Upon surfacing the destination list, a user is able to select a destination therein. In one embodiment, the target application related to the selected destination is launched such that the item linked to the destination is initiated.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a schematic diagram of an exemplary system architecture suitable for use in implementing embodiments of the present invention, in accordance with an embodiment of the present invention;

FIG. 3 is a flow diagram illustrating an overall method for presenting a destination list at a user-interface display, in accordance with an embodiment of the present invention;

FIG. 4 is a flow diagram illustrating an overall method for generating a destination list utilizing usage data corresponding to a target application, in accordance with an embodiment of the present invention;

FIGS. 5-7 are screen displays of exemplary display areas that illustrate a submenu area populated with destinations, in accordance with embodiments of the present invention.

### DETAILED DESCRIPTION

The subject matter is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide computerized methods, UIs, and computer-readable media having computer-executable instructions embodied thereon, for generating a destination list from usage data captured at a data store, and for rendering destinations within a submenu area upon detecting a request from a user. In embodiments, generating the destination list involves selecting items from a listing of frequently used items, a listing of recently used items, or any other listing of items compiled internally in an operating system or provided by a target application. Typically, the items are selected according to configuration settings provided by the target application. In embodiments, rendering destinations within a submenu area involves accessing the destination list associated with a launcher of the target application selected by the user and populating destinations from the destination list into a submenu area that is surfaced on the UI. The number and type of destinations that are populated within the submenu area are governed by properties of the submenu area.

Accordingly, in one aspect, the present invention provides one or more computer-readable media that has computer-executable instructions embodied thereon that, when executed, perform a method for presenting a destination list at a user-interface display. Initially, the method includes receiving user-initiated indications to view the destination list. Incident to receiving the user-initiated indications, a list-generation procedure is executed to construct the destination list. Generally, the list-generation procedure includes, at least, the following steps: retrieving recently used items and frequently used items as aggregated according to usage data; determining properties of a submenu area allocated for the destination list; and populating the submenu area with destinations according to the properties. In embodiments, the destinations are derived from the retrieved recently used items and the retrieved frequently used items. Incident to a user request, the destination list is surfaced on the user-interface display.

In another aspect, a computerized method is provided for generating a destination list utilizing usage data corresponding to a target application. Initially, the method includes automatically capturing the usage data corresponding to the target application. Typically, the usage data is ascertained from user-initiated activities associated with items managed by the target application. The usage data may be aggregated in a data store and may comprise a score and a timestamp. Generally, the score indicates the frequency of which the items are invoked, and the timestamp signifies the most recent time that the item was invoked. A listing of recently used items may be dynamically built according to the timestamp associated with each item. In addition, a listing of frequently used items may be dynamically built according to the score associated with each item. Destinations to these items within the listing of recently used items and the listing of frequently used items are stored at the destination list consistent with configuration settings thereof.

In yet another aspect, embodiments of the present invention relate to a computer system for populating a destination list with destinations to items utilizing one or more application programming interfaces (APIs). The computer system includes a target-application component for executing a recent-items API and an operating system component. Typically, the recent-items API captures usage data associated with the items managed by the target-application component. The operating-system component executes a list-generation procedure to construct the destination list. In embodiments, the list-generation procedure includes: calling the recent-items API associated with the target-application component; receiving the usage data from the recent-items API; dynamically constructing a listing of recently used items and a listing of frequently used items according to the usage data; determining configuration parameters of the destination list; populating the destination list with the destinations to the items according to the configuration parameters; and temporarily storing the populated destinations to the items in association with the destination.

Generally, embodiments of the present invention relate to constructing a destination list by way of a list-generation process. As used herein, the phrase “destination list” is not meant to be limiting and may encompass any set, collection, manifest, catalogue, record, or index of destinations. Further, destination list may refer to an actual listing embedded in computer-readable media, or a representation of a destination list that may be presented at a user-interface display. In one instance, the destination list is generated by the operating system (e.g., utilizing destinations associated with frequently used items and/or recently used items). In another instance, the destination list is generated at an application (e.g., providing destinations related to items managed by the application that have been accessed by a user). In yet another instance, a user is able to influence contents of the destination list (e.g., pinning a destination to the destination list). As such, it should be understood and appreciated that the destination list can take on many forms and can be created or modified by one or more entities using various editing techniques. Upon generation, the destination list can be stored in one or more locations, such as at an operating system or at a remote website.

In an exemplary embodiment, the destination list includes one or more destinations. The term “destinations” is used broadly herein and refers to locations of items that are identified by a target application. The locations of items may take the form of an address to a file, a universal naming convention (UNC) path to a folder or working directory, a uniform resource locator (URL) of a website, or any other string of characters that signifies a particular item. In embodiments, the item can include, but is not limited to, a file (e.g., document, media, content), a task (e.g., user-initiated action, command that is executable by a computing device), a folder, a directory, a website, an applet, or a device.

Having briefly described an overview of embodiments of the present invention and some of the features therein, an exemplary operating environment suitable for implementing the present invention is described below.

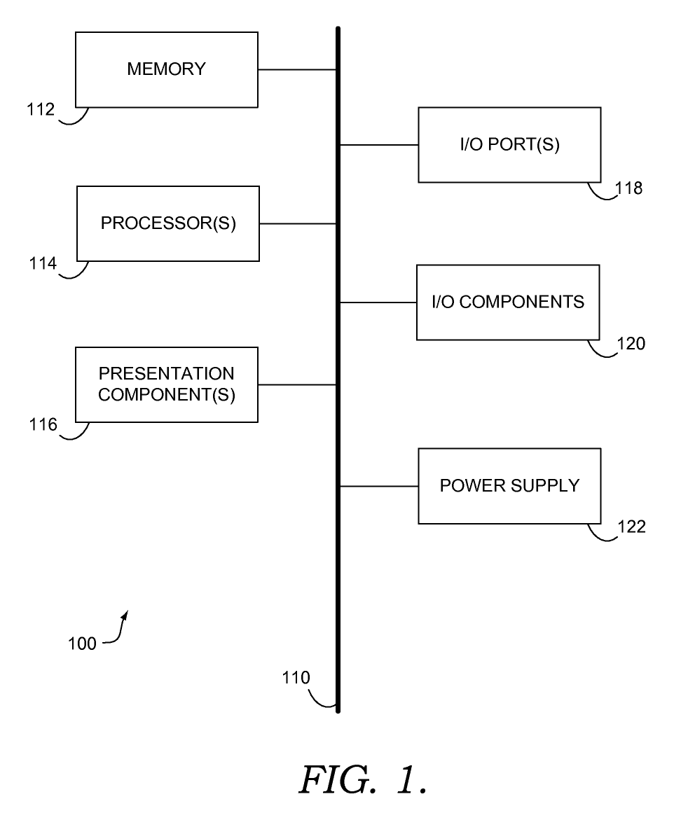

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks or implements particular abstract data types. Embodiments of the present invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear and, metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 1 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM; digital versatile disks (DVD) or other optical or holographic media; magnetic cassettes; magnetic tape; magnetic disk storage or other magnetic storage devices; carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in. Illustrative components include a microphone, joystick, game pad, satellite dish, scanner, printer, wireless device, etc.

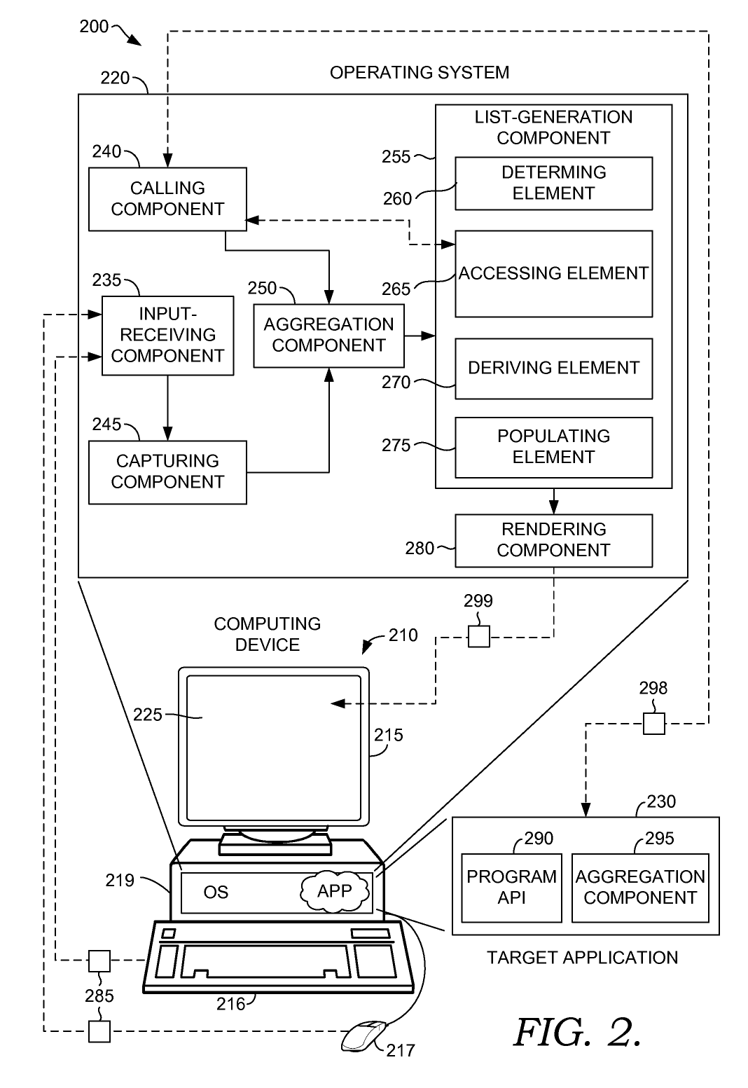

Turning now to FIG. 2, a schematic diagram of an exemplary system architecture 200 suitable for use in implementing embodiments of the present invention is shown, in accordance with an embodiment of the present invention. It will be understood and appreciated by those of ordinary skill in the art that the exemplary system architecture 200 shown in FIG. 2 is merely an example of one suitable computing environment and is not intended to suggest any limitation as to the scope of use or functionality of the present invention. Neither should the exemplary system architecture 200 be interpreted as having any dependency or requirement related to any single component or combination of components illustrated therein.

Exemplary system architecture 200 includes a computing device 210 for generating a destination list from usage data captured at a data store (e.g., registry or any other information-storage location internal or external to the operating system 220), and for rendering destinations within a submenu area upon detecting a request from a user. The computing device 210 may take the form of various types of computing devices. By way of example only, the computing device 210 may be a personal computing device (e.g., computing device 100 of FIG. 1), handheld device (e.g., personal digital assistant), consumer electronic device, various servers, and the like. Additionally, the computing device may comprise two or more electronic devices configured to share information therebetween.

In embodiments, the computing device 210 includes a display device 215, input devices 216 and 217, and hardware 219 with an operating system 220 installed thereon. The computing device 210 is configured to present a UI display 225 on the display device 215. The display device 215, which is operably coupled to the computing device 210, may be configured as any presentation component that is be capable of presenting information to a user, such as a monitor, electronic display panel, touch-screen, and the like. In one exemplary embodiment, the UI display 225 is configured to present a submenu area (not shown) initiated by the operating system 220, where the submenu area includes the destination list to a user. In another exemplary embodiment, the UI display 225 is capable of rendering a trigger area proximate to an application launcher icon that, when actuated, invokes the submenu area.

The input devices 216 and 217 are provided to provide input(s) affecting, among other things, a presentation of the destination list within the submenu area on the UI display 225. Illustrative devices include a key pad (as indicated by reference numeral 216), a mouse (as indicated by reference number 217), a joystick, a microphone, the I/O components 120 of FIG. 1, or any other component capable of receiving a user input and communicating an indication of that input to the computing device 210. By way of example only, the input devices 216 and 217 control the location of where a cursor tool is positioned (i.e., hovers) on the UI display 225 and/or the selection of buttons appearing on the UI display 225.

The operating system (OS) 220 refers generally to the software that manages the sharing of the resources of the computing device 210 and provides programmers with an interface used to access those resources. In operation, the operating system 220 interprets system data and detects user inputs (e.g., via the input devices 216 and 217), and responds by executing such processes as the following: prioritizing system requests (e.g., user-initiated request to view the destination list); allocating internal system resources; facilitating networking between the resources and/or devices, managing tasks (e.g., generating a destination list) and file systems; controlling output devices (e.g., rendering the destination list at the display device 215); and operating as a platform for programs residing thereon, such as target application 230.

In an exemplary embodiment, the operating system 220 includes an input-receiving component 235, a calling component 240, a capturing component 245, an aggregation component 250, a list-generation component 255, and a rendering component 280. In addition, the list-generation component 255 may include a determining element 260, an accessing element 265, a deriving element 270, and a populating element 275. This operating-system structure of the operating-system component 220 is but one example of a suitable structure that may be run on the computing device 210, and is not intended to suggest any limitation as to the scope of use or functionality of the invention. Neither should the illustrated operating system 220 be interpreted as having any dependency or requirement relating to any one or combination of the components/elements 235, 240, 245, 250, 255, 260, 265, 270, 275, or 280 as illustrated. In some embodiments, one or more of the components/elements 235, 240, 245, 250, 255, 260, 265, 270, 275, or 280 may be implemented as stand-alone applications. In other embodiments, one or more of the components/elements 235, 240, 245, 250, 255, 260, 265, 270, 275, or 280 may be integrated directly into the display device 215 of the computing device 210, the target application 230, or a combination thereof. By way of example only, the rendering component 280 may be housed in association with the display device 215, while the capturing component 245 may reside in the target application 230, thereby monitoring activities related to items managed by the target application 230. It will be understood by those of ordinary skill in the art that the components/elements 235, 240, 245, 250, 255, 260, 265, 270, 275, and 280 illustrated in FIG. 2 are exemplary in nature and in number and should not be construed as limiting.

Any number of components/elements may be employed to achieve the desired functionality within the scope of embodiments of the present invention. Although the various components/elements of FIG. 2 are shown with lines for the sake of clarity, in reality, delineating various components/elements is not so clear, and metaphorically, the lines would more accurately be grey or fuzzy. Further, although some components/elements of FIG. 2 are depicted as single blocks, the depictions are exemplary in nature and in number and are not to be construed as limiting (e.g., although only one display device 215 is shown, many more may be operably coupled to the computing device 210, thereby functioning in conjunction to present the UI display 225).

In embodiments, the input-receiving component 235 is configured to receive and process indications of commands 280 from the input devices 216 and 217. These indications of commands 280 include any outputs within a scope of outputs produced by the input devices 216 and 217. In one embodiment, the outputs include indications of user-initiated activities associated with the items managed by the target application 230. In another embodiment, the outputs include a user-initiated indication to view the destination list. In one instance, as discussed more fully below, the user-initiated indication to view the destination list is an indication to traverse a cursor tool into a trigger area rendered on the UI display 215. In another instance, the user-initiated indication to view the destination list is a selection of a button (e.g., a split button) presented on the UI display 225.

In embodiments, the capturing component 245 is configured as an underlying program that continuously monitors usage data that corresponds with particular applications. In an exemplary embodiment, the usage data is information related to user-initiated activities associated with the items managed by the target application 230. For instance, the usage data includes an indication that a user has opened a document managed by document-editing software (i.e., the target application 230). In another instance, the usage data includes an indication that the target application 230 has been active for over a prescribed amount of time, typically reported from a timer object (not shown). Although two different instances of the usage data have been described, it should be understood and appreciated that other usage data could be monitored and stored by the capturing component 245, and that the scope of functionality of the capturing component 245 is not limited to capturing the usage data shown and described.

In embodiments, the aggregation component 250 generates records from the usage data. Generally, the records include information associated with a particular item. For instance, the records comprise a score indicating the frequency at which an item is invoked and a timestamp indicating when the item was invoked. Records may also comprise an item shell that includes, among other things, an item identifier (e.g., a common namespace) and a location of the item, such as an address within the operating system 220, a pathway to a remote host, and the like. In an exemplary embodiment, records are indexed according to applications, such that records relating to an item are associated with the application that manages the item. In one instance, indexing includes storing the records in a table format at a data store. The table format lists records stored in a manifest underneath a heading depicting the application to which the records correspond; that is, the table format is generally usage data of a set of items collected together and sorted based on which application is used to invoke that particular set of items. In embodiments, a timestamp, a score, and an item shell (including an item identifier and a location of an item) may comprise elements of a record that is listed as an entry within the table format. By way of example only, the record may describe the item as a media file, such as a digital recording, and the associated record may include the following elements: a timestamp indicating the media file was opened at 12:31 PM, a score indicating that the media file is opened very frequently, an item identifier of “Hey Jude,” and a location of the media file on a C-drive in a “Beatles” folder.

As discussed above, the score is an indication of the frequency at which an item is invoked. In one instance, the score is calculated by incrementally increasing a running account each time the item is accessed. In addition, the running account may be incremented if a timer object reports that the time has been active for more than a prescribed amount of time. For instance, if the prescribed amount of time is four hours and a file has been open for five hours, the score for the file is incremented twice, once for initially opening the file and again for meeting the prescribed time criteria. Incrementing a score because an item is active for a period of time is based on the assumption that a user is more apt to access this item again, as opposed to an item that is opened for a brief duration of time.

In a more sophisticated embodiment, a decay algorithm is applied to the scores of each item. Generally, the decay algorithm reduces a score for an item that has not been used recently. In operation, the decay algorithm allows scores of individual items to increment until a combined-score limit has been reached. At this point, the score associated with the item that is being accessed is incremented, as before in the degraded model above, but the scores of each of the other items in the set of items managed by an application are decreased by a fractional point. In other words, points are given to items until a maximum point total for a set of items has been reached. At that point, when a point is given to an item, a fractional point is taken away from the other items in the set of items, where the sum of the fractional points equals a single point. By way of example only, a send-email task (i.e., the item) is one of twenty tasks (i.e., the set of items) associated with an email application. If a user initiates the send-email task, by way of the indication of a command 285, the score associated with the email task is increased by a point, while the scores of the other tasks are reduced by 1/19^{th} of a point. This practice of reducing the scores associated with the items in the set of items is based on the assumption that a user is more likely to access a recently activated item than one accessed in the past. It should be understood and appreciated that the scope of the present invention is not limited to the methods for calculating a score and decaying the score described above. Embodiments of the present invention contemplate other models for calculating a score, and other decay algorithms for accurately reflecting a user's current preference of which items the user desires to view in a destination list.

As discussed above, the records of items are listed as entries in a manifest associated with an application that manages those items. The manifest may include listings of items, wherein each listing is an aggregation of items according to a logical scheme. One embodiment of a listing is a listing of recently used items. The listing of recently used items is built according to the timestamp associated with each item in the set of items. In one instance, the list is built by ranking the items from the item with a most recent timestamp to the item with an earlier timestamp. Another embodiment of a listing is a listing of frequently used items. The listing of frequently used items is built according to the score associated with each item in the set of items. In one instance, the list is built by comparing each score of an item against a predefined threshold score and populating the listing of frequently used items with those items with a score that overcomes the threshold. In this way, only those items that are frequently accessed by a user, as indicated in the usage data, are incorporated in the listing of frequently used items.

Although two different listings that may be included in the manifest have been discussed, it should be understood and appreciated that other listings of items (based on the timestamp, the score, other criteria, or any combination thereof) could be built, and that embodiments of the invention are not limited to those listings described herein. In addition, the listings can be built dynamically. That is, the listings are continuously or periodically updated in an automated fashion by the aggregation component 250 (e.g., utilizing a recent-items application programming interface). In one instance, updating is triggered by changes to the usage data collected by the capturing component 245.

In an exemplary embodiment, the aggregation component 250 utilizes configuration parameters to build the listings. Accordingly, the configuration parameters comprise rules that dictate how many, and which, items are to be indexed in a particular listing. The configuration parameters may encompass a wide scope of criteria or properties provided by any source. In one instance, the configuration parameters may be provided by the operating system 220 (e.g., the predefined threshold). In another instance, the configuration parameters are provided by a user (e.g., preferred websites that comprise a favorites listing). In yet another embodiment, the configuration parameters are provided by the target application 230 (e.g., which recently-visited websites are included in a listing).

In embodiments, manifests of items may also be collected and edited by the target application 230. Generally, the target application 230 is any program that may be launched and manipulated by the operating system 220. These manifests may include listings of items managed by the target application 230 that are built according to the configuration parameters provided by the target application. Initially, building includes capturing usage data by a program API 290 that is controlled by the target application 230. In one instance, the program API 290 operates substantially similar to the capturing component 245. That is, the program API 290 monitors user activities and stores usage data as records in a listing. The aggregation component 295 dynamically builds listings by arranging items in the set of items according to configuration settings. The configuration settings may indicate which listings are used to generate a destination list and which items are utilized when building a particular listing. In embodiments, the configuration settings direct the aggregation component 295 to generate a destination list with one, two, or several separate listings. In addition, the types of listings selected for the destination list may be indicated by the configuration settings. For instance, the configuration settings may indicate that the destination list should be built from a listing of important tasks, as predefined by the target application 230, a listing of preferred commands, as provided by a user, and a listing of recently/frequently opened files, as determined from user activity monitored by the program API 290. Although a particular embodiment of building a destination list using exemplary configuration settings is described above, it should be understood and appreciated that the configuration settings may guide the aggregation component 295 to build a destination list utilizing any number and type of listings. Further, this completed destination list may be provided to the operating system 220 regularly, or upon a detecting an indication to surface the destination list.

In embodiments, the configuration settings indicate which items are incorporated into a particular listing. Accordingly, the configuration settings may comprise information related to which items are predefined as being in a listing (e.g., top-five most important tasks), which items are selected by a user (e.g., preferred items) for incorporation into a listing, and which items to add to a listing with reference to usage data gathered by the program API 290. By way of example only, a calendar application (i.e., the target application 230) builds a listing of upcoming appointments from saved appointments (i.e., the set of items) that is limited to the ten most recent appointments beyond the present time (i.e., utilizing configuration parameters provided by the target application 230). In another example, a web-browser application (i.e., target application 230) builds a listing of favorite websites that is limited to the user-preferred websites (i.e., utilizing configuration parameters provided by the user). Item shells 298 describing items indexed by listings built by the target application 230 may be provided to the calling component 240 on the operating system 220, as more fully discussed below.

As discussed above, the listings that comprise the manifests are dynamically built by the operating system 220 or the target application 230. The process of building may be executed in series, in parallel, or asynchronously with executing a list-generation procedure, as more fully discussed below with reference to the list-generation component 255. As such, it should be understood and appreciated that building a listing within a manifest and constructing a destination list may not be interdependent upon each other.

Returning to an exemplary structure of the operating system 220 of FIG. 2, the list-generation component 255 will now be described. Generally, the list-generation component 255 is configured to construct a destination list utilizing a list-generation procedure. Typically, the destination list is generated incident to receiving one or more user-initiated indications to view the destination list as provided via the indication of a command 285 from the display devices 216 and 217. However, the list-generation procedure may be executed independent of a request, such as at regular intervals or in response to a prompt internal to the operating system 220. Because the contents of the destination list are updated automatically, the destination list reflects items that are relevant to a user's current task.

In embodiments, the list-generation component 255 may include the determining element 260, the accessing element 265, the deriving element 270, and the populating element 275. The determining element 260 is generally configured to determine the appropriate data stores from which to select item shells (e.g., item shell 298) and to determine properties of a submenu area allocated for displaying the destination list. In an exemplary embodiment, configuration settings are utilized to determine the appropriate data stores, and listings within the data stores, to access. Generally, the configuration settings comprise rules that guide the accessing element 265 to retrieve the proper item shells from a proper listing within a data store. The configuration settings may encompass a wide scope of criteria or properties provided by any source. In one instance, the configuration settings may be provided by the operating system 220. By way of example only, the configuration settings provided by the operating system 220 may direct the accessing element 265 to retrieve ten item shells from each of the listing of frequently used items and the listing of recently used items, where these listings reside in a data store on the operating system 220. In another instance, the configuration settings are provided by the target application 230. By way of example only, the configuration settings provided by the target application 230 may direct the accessing element 265 to retrieve five item shells from each of the listing of upcoming appointments and the listing of favorite websites (located in a data store controlled by the target application 230) and a listing of frequently used items. Accordingly, in addition to pointing the accessing element 265 to appropriate data stores for accessing item shells, the configuration settings assist in determining which, and how many, item shells to retrieve for incorporation into the destination list.

In an exemplary embodiment, determining properties of the submenu area allocated for displaying the destination list includes retrieving attributes of the submenu area, such as size (e.g., width and height) and/or area required by each item shell once converted to a destination. In one embodiment, these attributes may be gathered by requesting coordinates of the submenu area. Based on the properties of the submenu area, the determining component 260 is capable of calculating the number of item shells that can be entered into the destination list. In particular, these properties assist in determining how many item shells may be selected for entry in each of the category heads of the destination list. In embodiments, the category heads are representations of the determined listings that are identified for accessing. For instance, a category head “Frequent Items” would represent the listing of frequently used items, while the category head “Recent Websites” would represent the listing of recently-visited websites. Thus, by utilizing the configuration settings and the properties of the submenu area in conjunction, the determining element 260 is able identify (a) the appropriate item shells for constructing the destination list and (b) where the identified item shells are located.

The accessing element 265 retrieves the appropriate item shells from the proper listings/data stores as identified by the determining component 260. In embodiments, a calling component 240 is established to communicate with the target application 230 in order to retrieve the item shells 298 that are monitored and maintained thereby, as discussed above with reference to the aggregation component 295. Although the calling component 240 is shown and described as being operably coupled to the target application 230, embodiments of the present invention contemplate the accessing element asking the calling component 240 to communicate with any local or remote data store to retrieve the appropriate item shells. Accordingly, the calling component 240 facilitates accessing listings exposed by any application that monitors and records usage data. In this way, the list-generation process is extensible to retrieve item shells from a variety of applications, including applications that are developed after installing the operating system 220 on the computing device 210.

Upon retrieving the appropriate item shells, the deriving element 265 creates the destination list from destinations derived from the item shells. As discussed above, the destinations are derived from retrieved item shells such that when surfaced at the UI display 225, the destinations indicate the items that correspond to the item shells and, typically, provide a link to the items. In embodiments, the indication of the items is based on the item identifier expressed by the item shell, and the link to the items is pulled from the location of the item, which is also included within the item shell. As such, upon receiving an indication of a user-initiated selection at a destination surfaced within the submenu area, the item identified by the destination is invoked by following the link to the item. Generally, invoking an item includes launching an application that manages the item and automatically opening the item within the application without requiring additional user participation.

In embodiments, the populating element 275 is configured to populate the destination list with derived destinations. Typically, the destinations are hierarchically arranged (e.g., according to an ordering) as independent entries within the destination list. The ordering may be based on the configuration settings, as discussed above, or any other method for ordering known to those of skill in the relevant field. In one instance, destinations derived from ranked item shells within a listing are ordered according to the ranking. By way of example only, destinations derived from the five highest ranked item shells in the listing of frequently used items are arranged with the first-ranked destination as the top entry under a category head of the destination list, and the fifth-ranked destination as the bottom entry. Category heads, which are based on listings as discussed above, are inserted into the destination list to divide groupings of destinations from a common listing. Accordingly, users are quickly guided to a section of the submenu area that has destinations relevant to their present task.

In embodiments, the rendering component 280 is configured to provide the generated destination list 299, or a representation thereof, to the UI display 225. In particular, the rendering component 280 may provide for presenting the destinations and category heads, as arranged by the population element 275, within the submenu area. As such, the user is provided with a rich list of destinations that point to items associated with a selected application.

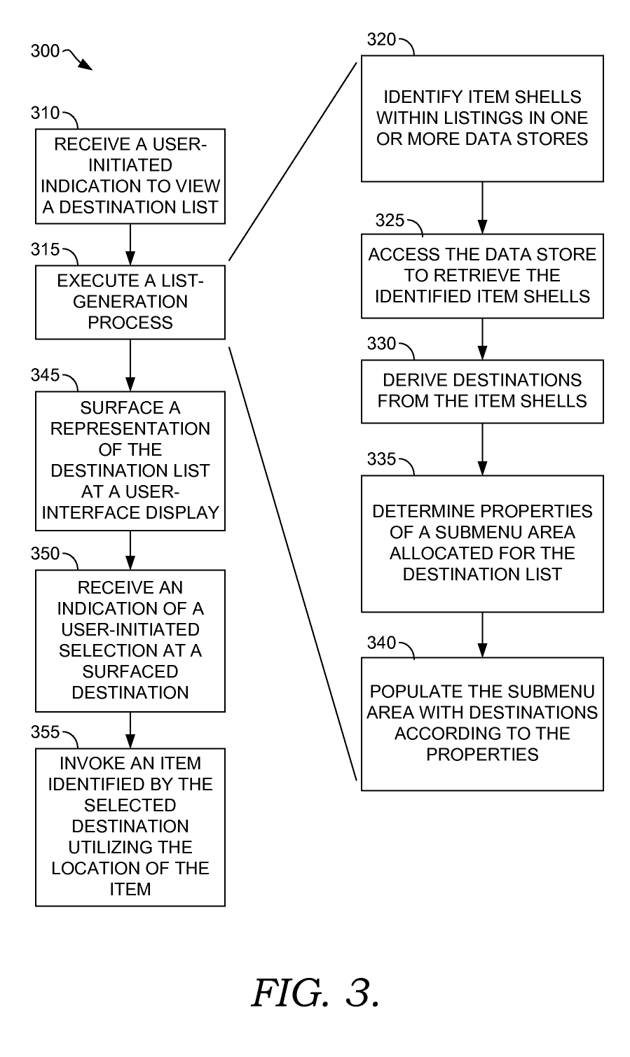

Turning to FIG. 3, a flow diagram is shown that illustrates an overall method 300 for presenting a destination list at a user-interface display, in accordance with an embodiment of the present invention. Initially, a user-initiated indication to view a destination list is received (e.g., utilizing the input-receiving component 235), as indicated at block 310. The indication may include, at least, one or more of the following actions: traversing a cursor tool into a trigger area proximate to an application launcher; selecting a split button rendered on a UI display (e.g., UI display 225); hovering the cursor tool over an application icon pinned to a taskbar; or selecting an application launcher within an application menu. Incident to receiving the indication to view a destination list, a list-generation process is executed (e.g., utilizing the list-generation component 255), as indicated at block 315. Generally, the list-generation process constructs a destination list by performing, at least, the following steps: identifying item shells at a data store, accessing the data store to retrieve the identified item shells, deriving destinations from the item shells, determining properties of a submenu area, and populating the submenu area with the destinations.

In particular, the item shells are identified within listings in one or more data stores (e.g., utilizing the determining element 260), as indicated at block 320. The listings may be one or more of the listing of recently used items, the listing of frequently used items, or a listing maintained by an application. As such, the list-generation process is extensible to selecting item shells from various local and remote listings. As more fully discussed above, the item shells are identified according to configuration settings of the destination list. As indicated at block 325, the identified item shells are retrieved from their respective listings upon accessing the data stores (e.g., utilizing the accessing element 265). Destinations are derived from the identified item shells (e.g., utilizing the deriving element 270), as indicated at block 330. Typically, the destinations are derived from retrieved item shells such that when surfaced at a UI display, the destinations indicate the items that correspond to the item shells and, typically, provide a link to the items. In embodiments, the indication of the items is based on the item identifier exposed by the item shell, and the link to the items is pulled from the location of the item embedded in the item shell. In other instances, the item shells are generally stored shortcuts (i.e., links) to the appropriate items that comprise the destination list. As indicated at block 335, properties of a submenu area allocated for the destination list are determined. In one instance, determining includes measuring the size of the submenu area to determine a window height, a window width, and other dimensional attributes of the submenu area. The submenu area may then be populated by the destinations in accordance with the determined properties (e.g., utilizing the populating element 275), as indicated at block 340.

As indicated at block 345, the destination list is surfaced within the submenu at the UI display (e.g., utilizing rendering component 280). Incident to surfacing the destination list, a destination within the submenu area may be indicated by a user-initiated selection, as indicated at block 350. The selection may comprise any method of selecting content presented on a UI display known in the relevant field. As indicated at block 355, upon detecting the indication, an item identified by the selected destination (e.g., by way of the item identifier) is invoked. Generally, invoking the item includes launching an application that manages the item and opening the item within the application.

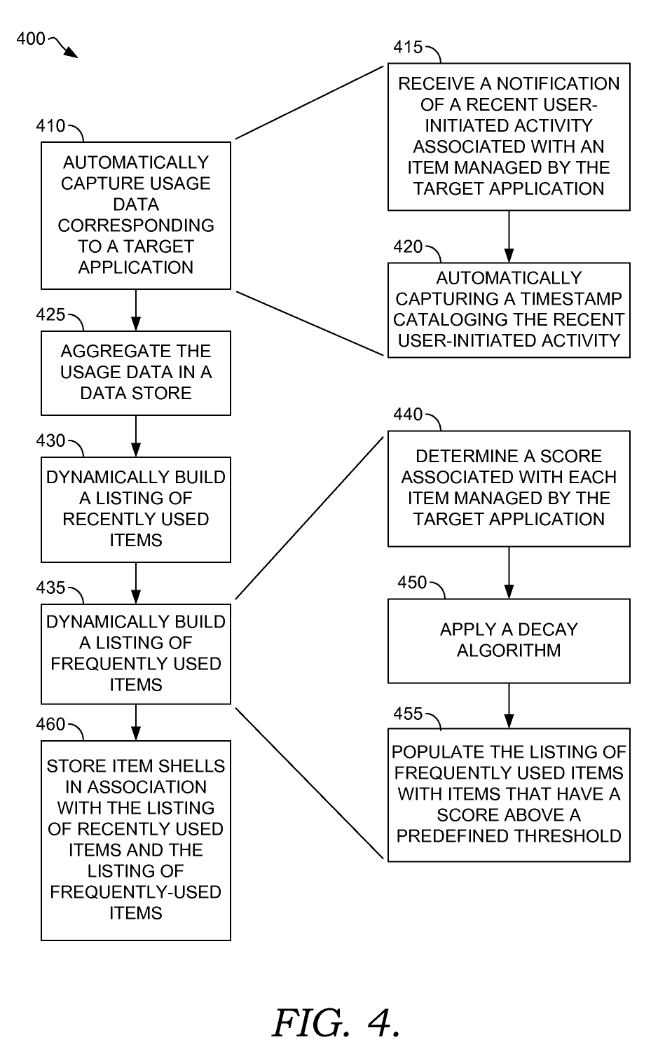

With reference to FIG. 4, a flow diagram is shown that illustrates an overall method 400 for generating a destination list utilizing usage data corresponding to a target application, in accordance with an embodiment of the present invention. Initially, as indicated at FIG. 410, usage data that corresponds to a target application is automatically captured. In embodiments, automatically capturing usage data includes receiving a notification of a recent user-initiated activity associated with an item managed by the target application, as indicated at block 415, and automatically capturing a timestamp cataloging the recent user-initiated activity, as indicated at block 420. As indicated at block 425, the usage data is aggregated in a data store. As indicated at block 430, a listing of recently used items is dynamically built based on the usage data. In one instance, the listing of recently used items is ordered by ranking the most recently used item first, according to a comparison of the timestamps, the second most recently used item second, and so on.

As indicated at block 435, a listing of frequently used items is dynamically built utilizing the usage data. Initially, the listing of frequently used items is dynamically built by determining a score associated with each item managed by the target application, as indicated at block 440. A decay algorithm is applied to the scores of the items, as indicated at block 450, thereby increasing the relevance of the listing. As indicated at block 455, the listing of frequently used items is populated with items having a score above a predefined threshold. In one embodiment, the predefined threshold corresponds to an attribute of the configuration settings that governs which, if any, items from the listing of frequently used items are represented in the destination list. As indicated at block 460, item shells are stored in association with the above listings. In one instance, destinations are derived from the item shells while, or upon, building the listings. These destinations to items may be indexed based on an ordering of item shells within the listings above.

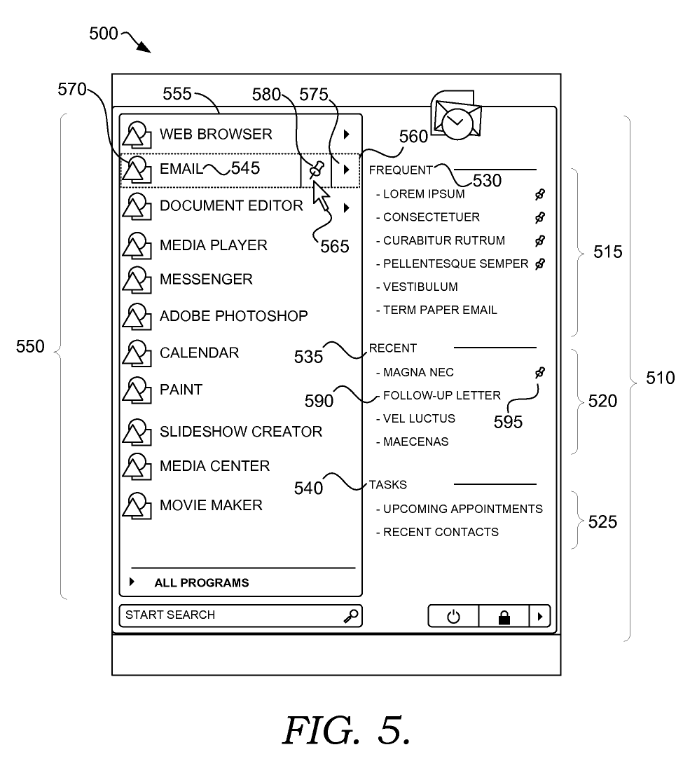

With reference to FIGS. 5-7, screen displays are shown that illustrate exemplary display areas that include a submenu area populated with destinations, in accordance with embodiments of the present invention. Turning to FIG. 5, an exemplary display area 500 is shown that includes a submenu area 510 populated with destinations 515, 520, and 525. As discussed above, the content of the submenu area 510 is the destination list. Accordingly, the configuration settings of the destination list guide the arrangement of the destinations 515, 520, and 525 within the submenu area 510. In the embodiment illustrated, three listings are accessed for populating the destination list, which are represented by category heads 530, 535, and 540. In particular, the category head “Frequent” 530 identifies the destinations 515 therebelow as representing frequently used items. The category head “Recent” 535 identifies the destinations 520 therebelow as representing recently used items. In addition, the category head “Tasks” 540 identifies destinations 525 therebelow as items that are tasks which can be performed by an email application. As such, this destination list represented in the submenu area 510 is extensible to listings managed by an email application.

The email application is represented by application launcher 545 and resides within a listing of application launchers 550. In embodiments, an icon 570 related to the application launcher 545 is presented. The listing 550 is arranged by recently-launched applications, frequently-launched applications, or any other ordering scheme known in the relevant field. In one embodiment, the listing 550 is surfaced within a menu area 555, which can be invoked by selecting a button or trigger (not shown) on the exemplary display area 500. In another embodiment, the listing 550 is incorporated in a general menu (e.g., invoked upon selecting a “Start” button). Proximate to the application launcher 545 is a trigger area 560. In the embodiment shown, the trigger area 560 overlays a visual display of the application launcher 545.

In operation, in one embodiment, upon a cursor tool 565 entering the trigger area 560, the submenu area 510 is surfaced. Typically, a selection within the trigger area 560 will launch the application (e.g., target application 230) that is identified by the application launcher 545. In another embodiment, a split button 575 is surfaced upon the cursor tool 565 entering the trigger area 560. Selection of the split button 575 causes the submenu area 510 to surface. Also, a pin button 580 may be surfaced upon the cursor tool 565 entering the trigger area 560. Selection of the pin button 580, with reference to a particular destination 590 causes the particular destination 590 to be “pinned” to the destination list. Pinning implies that the particular destination is appended to the destination list, thus consistently surfaced with the submenu area 510 (until the particular destination 590 is deselected as being pinned). In embodiments, a pin indicator 595 signifies that the particular destination 590 is pinned to the destination list. As more fully discussed above, selection of the particular destination 590, or any of the destinations 515, 520, and 525 of the destination list 510, invokes the item linked to the particular destination 590.

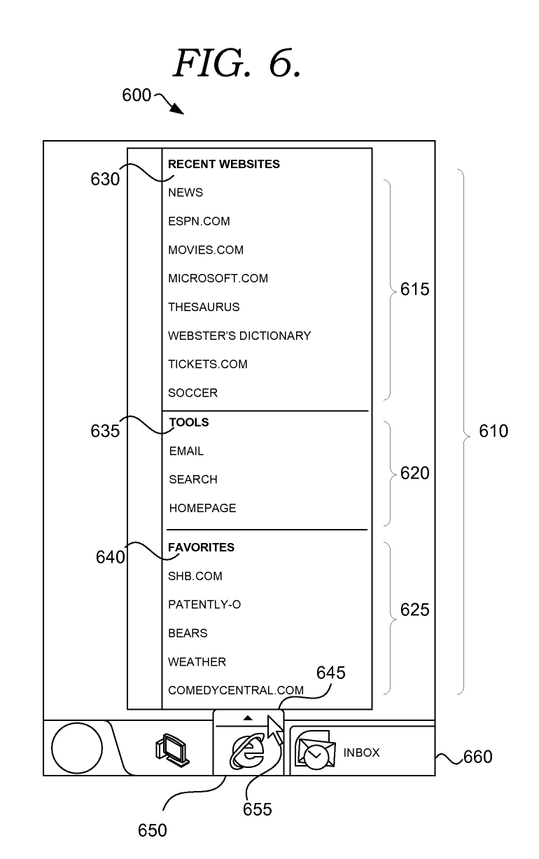

Turning to FIG. 6, an exemplary display area 600 is shown that includes a submenu area 610 populated with destinations 615, 620, and 625. As discussed above, the content of the submenu area 610 is the destination list. Accordingly, the configuration settings of the destination list guide the arrangement of the destinations 615, 620, and 625 within the submenu area 610. In the embodiment illustrated, three listings are accessed for populating the destination list, which are represented by category heads 630, 635, and 640. In particular, the category head “Recent Websites” 630 indicates that the destinations 615 therebelow identify items that are websites which have been recently visited. Typically, these items are identified by item shells within a listing of recently-visited websites managed by a web-browser application. The category head “Tools” 635 indicates the destinations 620 therebelow identify tools that are available within the web-browser application. In embodiments, the destinations 615, 620, and 625 reference tools that have been recently executed, frequently executed, or identified as a preferred tool by a user. In addition, the category head “Favorites” 640 indicates the destinations 625 therebelow are destinations that link to a user's favorite websites. In an exemplary embodiment, selection of one of the destinations 625 invokes the selected destination. In particular, invoking the selected destination includes launching the web-browser application and instructing the web-browser application to automatically open a web page at a website referenced by the selected destination. As such, this destination list represented in the submenu area 610 is extensible to listings managed by a web-browser application as well as to listings maintained according to user preferences.

In operation, the submenu 610 is surfaced upon selection of a split button 645 proximate to an application launcher 650 that, upon selection, launches the web-browser application. The application launcher 650 is included within a taskbar 660. Inclusion within the taskbar 660 may be accomplished automatically by an operating system, or manually by a user by pinning the application launcher 650 thereto. In one embodiment, the split button 645 is surfaced upon a cursor tool 655 entering within a trigger area (not shown) proximate to, or substantially overlaying, the launcher application 650. In another embodiment, the split button 645 is consistently surfaced adjoining the application launcher 650. Upon selection of the split button 645, the submenu area 610 is surfaced, thereby presenting the destination list.

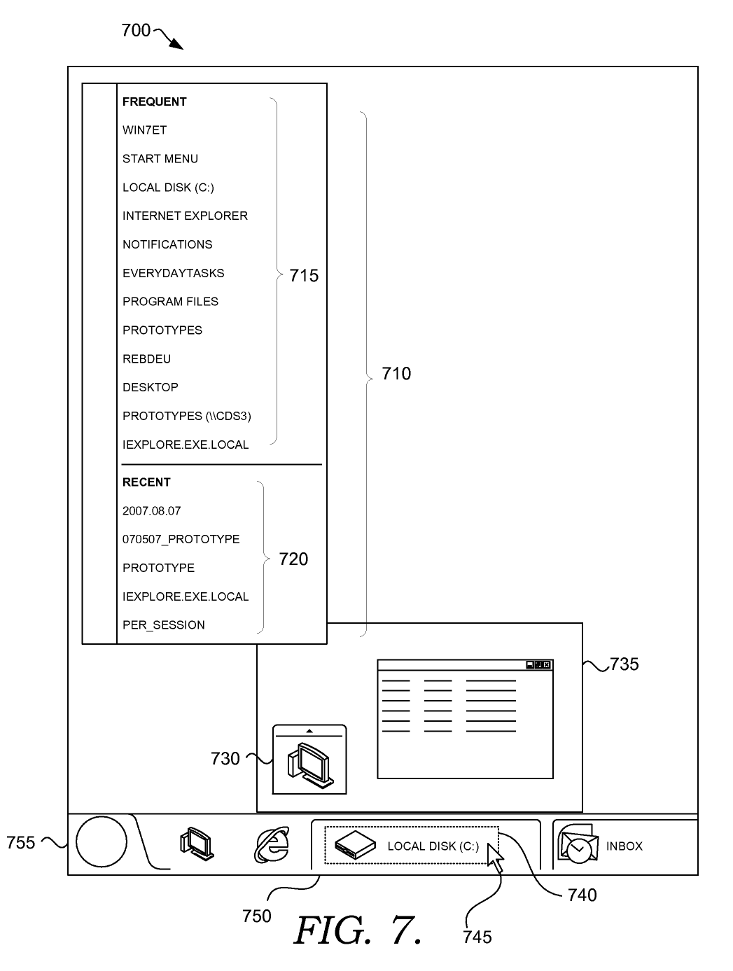

Turning to FIG. 7, an exemplary display area 700 is shown that includes a submenu area 710 populated with destinations 715 and 720. In the embodiment illustrated, two listings are accessed for populating the destination list, the listing of frequently used items, referenced by the destinations 715, and the listing of recently used items, referenced by the destinations 720. In operation, the submenu 710 is surfaced upon selection of a split button 730 located on a preview menu 735. The preview menu 735 is surfaced upon a cursor tool 745 entering within a trigger area 740 that substantially overlies an application launcher 750 pinned to a taskbar 755. In the embodiment illustrated, the application launcher 750, upon selection, launches a directory-navigation application to find particular documents. The preview menu presents a thumbnail view of a page in a directory with documents listed therein. Additionally, the preview menu 735 includes the split button 730. Selection of the split button 730 surfaces the submenu area 710; accordingly, the destinations 715 and 720 are surfaced as suggested by the destination list.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for presenting a destination list at a user-interface display, the method comprising:
receiving one or more user-initiated indications to view the destination list;
incident to receiving the one or more user-initiated indications, executing a list-generation procedure to construct the destination list, the list-generation procedure comprising:
(1) determining properties of a submenu area allocated for the destination list;
(2) retrieving recently used items and frequently used items as aggregated according to usage data;
(3) populating the submenu area with destinations according to the properties, wherein the destinations are derived from the retrieved recently used items and the retrieved frequently used items; and
surfacing the destination list on the user-interface display.

2. The one or more computer-readable media of claim 1, wherein the list-generation procedure further comprises:
identifying item shells associated with each of the retrieved recently used items and the retrieved frequently used items, each of the item shells including an item identifier and a location of an item corresponding to the item shell; and
deriving the destinations from the item shells utilizing the item identifier, wherein each of the destinations indicating an identity of the item represented thereby.

3. The one or more computer-readable media of claim 2, further comprising:
receiving an indication of a user-initiated selection at a destination surfaced within the destination list; and
launching the item identified by the selected destination utilizing the location of the item.

4. The one or more computer-readable media of claim 1, wherein receiving one or more user-initiated indications to view the destination list comprises receiving an indication to view the destination list associated with a target application.

5. The one or more computer-readable media of claim 4, wherein the usage data comprises a score indicating the frequency of which an item is invoked and a timestamp signifying the most recent time that the item was invoked.

6. The one or more computer-readable media of claim 4, wherein retrieving recently used items and frequently used items comprises retrieving the recently used items and the frequently used items managed by the target application.

7. The one or more computer-readable media of claim 6, wherein receiving one or more user-initiated indications to view the destination list comprises detecting a cursor tool entering within a trigger area presented on the user-interface display, wherein the trigger area is linked to the target application such that a user-initiated selection of the trigger area invokes the target application.

8. The one or more computer-readable media of claim 7, wherein the trigger area is located on a task bar rendered on the user-interface display.

9. The one or more computer-readable media of claim 7, wherein the trigger area is located on a menu comprising a listing of application launchers, the listing of application launchers including a launcher for the target application, wherein each application launcher within the listing of application launchers is provided with a trigger area.

10. The one or more computer-readable media of claim 7, wherein the trigger area is a selectable split button, wherein the destination list on the user-interface display is anchored to a location of the selectable split button.

11. The one or more computer-readable media of claim 1, further comprising:
receiving an indication of a user-initiated selection at a destination surfaced within the destination list; and
pinning the indicated destination to the destination list such that the indicated destination is consistently populated into the submenu until an indication of a user-initiated dismissal, with respect to the indicated destination, is received.

12. A computerized method for generating a destination list utilizing usage data corresponding to a target application, the method comprising:
automatically capturing the usage data corresponding to the target application, wherein the usage data is ascertained from user-initiated activities associated with items managed by the target application;
aggregating the usage data, wherein the usage data comprises a score indicating the frequency of which the items are invoked and a timestamp signifying the most recent time that the item was invoked;
dynamically building a listing of recently used items according to the timestamp associated with each item;
dynamically building a listing of frequently used items according to the score associated with each item; and
at least temporarily storing destinations to the items within the listing of recently used items and destinations to the items within the listing of frequently used items at the destination list consistent with configuration settings thereof.

13. The method of claim 12, wherein the configuration settings comprise rules that dictate the number of the destinations to the items within the listing of recently used items and the number of the destinations to the items within the listing of frequently used items that are temporarily stored within the destination list.

14. The method of claim 12, further comprising:
receiving a notification of a recent user-initiated activity associated with an item managed by the target application;
automatically capturing a timestamp cataloging the recent user-initiated activity;
updating the recently used items according to the timestamp; and
updating the listing of frequently used items upon incrementing a score associated with the item.

15. The method of claim 14, wherein dynamically building a listing of frequently used items according to the score associated with each item comprises applying a decay algorithm to the score associated with items that are not indicated by the notification of a recent user-initiated activity, wherein the decay algorithm decreases the score of the items that are not indicated based on a number of items within the listing of frequently used items.

16. The method of claim 12, wherein automatically capturing usage data corresponding to a target application comprises detecting each time the target application is invoked and a duration that the target application is active, wherein the usage data is stored in a data store.

17. The method of claim 12, wherein dynamically building a listing of frequently used items according to the score associated with each item comprises:
determining the score associated with each item managed by the target application; and
comparing the determined score against a predefined threshold score; and
populating the listing of frequently used items with items having a score that overcomes the predefined score.

18. A computer system for populating a destination list with destinations to items, the system comprising:
an operating-system component for determining configuration parameters of a destination list; and
a target-application component for executing a list-generation procedure to construct the destination list with items managed by the target-application component, the list-generation procedure comprising:
(1) calling the operating system component to retrieve the configuration parameters;
(2) interrogating configuration settings to select the items for incorporation into the destination list;
(3) dynamically constructing listings according to the configuration settings, wherein each of the listings comprise a portion of the selected items managed by the target application;
(4) populating the destination list with the destinations to the items within the constructed listings according to the configuration parameters; and
(6) communicating the destination list to the operating-system component.

19. The system of claim 18, wherein configuration settings of the target-application component are configured to influence the number and type of the listings that are accessed when populating the destination list.

20. The system of claim 18, wherein the target application component is further configured to capture user activity associated with a portion of the items managed by the target-application component and store usage data related to the user activity as configuration settings, wherein the configuration settings comprise at least one of usage data, preferred settings configured by the user, or predefined settings maintained by the target-application component.
